(19) United States
(12) Patent Application Publication
(10) Pub. No.: US 2013/0106227 A1
(43) Pub. Date: May 2, 2013

(54) ELECTRIC ROTATING MACHINE

(71) Applicant: Suzuki Motor Corporation, Shizuoka (JP)

(72) Inventor: Masahiro AOYAMA, Shizuoka (JP)

(73) Assignee: SUZUKI MOTOR CORPORATION, Shizuoka (JP)

(21) Appl. No.: 13/654,462

(22) Filed: Oct. 18, 2012

(30) Foreign Application Priority Data
Oct. 27, 2011 (JP) 2011-235980

(51) Int. Cl. H02K 1/27

(52) U.S. Cl. 310/156.53

(57) ABSTRACT

An electric rotating machine 10 includes a stator 11 having a plurality of teeth 15 facing a rotor 12, and a plurality of slots 18 providing spaces for winding coils around the teeth. The rotor has a pair of permanent magnets 16 embedded therein and located in a “V” shape configuration so as to let magnetic force act on the teeth such that the rotor within said stator is driven to revolve by reluctance torque and magnet torque. The permanent magnets are located in a way that when the pair of permanent magnets including a flux barrier in the rotor corresponding to six slots in the stator form a magnetic pole, an effective magnetic pole opening angle θ, having a vertex on the rotor axis, for the magnetic pole falls in an angular range 144°≦θ (in electric degrees)≦154.3° effective for reducing harmonic of the specific order in superimposition on a magnetic flux waveform passing through one of the teeth.

### RELATED APPLICATION

The present application claims priority to Japanese Patent Application No. 2011-235980 filed on Oct. 27, 2011, the entire content of which is being incorporated herein by reference.

### TECHNICAL FIELD

The present invention relates to an electric rotating machine and more particularly to a permanent magnet electric machine capable of acting as an electric motor providing high quality drive.

### BACKGROUND ART

Electric rotating machines are required to have varying characteristics with different types of equipment in which they are used. For example, it is required that an electrical machine acts as a variable speed motor over a wide range as well as a high torque motor for low revolution speed operation when it is used, as a traction motor, in a hybrid electric vehicle (HEV) with an internal combustion engine or an electric vehicle (EV) as a driving source.

It is proposed for an electric machine with such characteristics to construct by adopting an interior permanent magnet (IPM) structure in which a plurality of pairs of permanent magnets are embedded in a rotor in a way that the magnets of each pair are located in a “V” shape configuration opening toward the rotor periphery because it is advantageous to use a structure that can effectively utilize reluctance torque together with magnetic torque, see e.g. patent literatures 1 and 2.

### PRIOR ART DOCUMENT

### Patent Literature

Patent Literature 1: JP patent application laid-open publication No. 2006-254629 (P2006-254629 A)
Patent Literature 2: JP patent application laid-open publication No. 2008-104323 (P2008-104323 A)

### SUMMARY OF THE INVENTION

Adopting the IPM structure enables an electric machine to make effective use of reluctance torque because q-axis magnetic path is kept by permanent magnets of each pair, embedded in a rotor, located in a “V” shape configuration. This increases the proportion of reluctance torque to magnetic torque and also saliency ratio (Ld/Lq), a ratio between inductance in d-axis and inductance in q-axis, resulting in increased tendency of space harmonics of the higher order to overlap flux waveform. The direct axis or d-axis is aligned with a direction of flux generated by magnetic poles and acts as a center axis between each pair of permanent magnets located in “V” shape, while the quadrature axis or q-axis is at an angle of 90 in electric degrees from the d-axis electrically and magnetically and acts as a center axis between the adjacent magnetic poles (i.e., the adjacent pairs of permanent magnets).

This causes high torque ripple, i.e., the difference between maximum and minimum torque during one revolution, in such electric rotating machine. The high torque ripple causes an increase in oscillation of the machine and electromagnetic noise. Especially, electromagnetic noise is desired to be reduced as much as possible because it gives an unpleasant sound to occupant (s) in a vehicle having, as an electric drive, the electric machine due to a relatively high frequency of the electromagnetic noise to that of noise generated by drive of an internal combustion engine.

On the other hand, oscillation becomes loss to cause a reduction in efficiency of performance of the electric machine although highly efficient performance is demanded to generate a desired driving force efficiently with less consumption of electricity.

The above listed Patent Literatures 1 and 2 describe various conditions in the structure of electric rotating machines in order to improve energy efficiency, but the various conditions cannot provide such low torque ripple as to reduce oscillation and noise.

Thus, an object of the present invention is to provide an electric rotating machine capable of providing a high quality rotating drive with reduced oscillation and noise by lowering torque ripple.

A first aspect of the present invention provides an electric rotating machine comprising a rotor with a rotor shaft located on a rotor axis and a stator rotatably receiving the rotor,

wherein said stator includes a plurality of teeth portions, which extend towards a peripheral surface of said rotor and terminate at inner peripheral surfaces facing the peripheral surface of said rotor, and a plurality of slots, each between the adjacent two of the teeth portions, providing spaces for winding coils around said teeth portions for input of driving electric power,

wherein said rotor has a plurality of permanent magnets embedded therein so as to let magnetic force act on that surface portions of the teeth which are opposed to the permanent magnets,

wherein said rotor within said stator is driven to revolve by reluctance torque derived from magnetic flux passing through said teeth portions, rear surface side of the teeth portions and said rotor when current passes through said coils and magnet torque in the form of attraction and repulsion derived from interference with said permanent magnets,

wherein said permanent magnets are located in a way that when a set of permanent magnets of said plurality of permanent magnets in said rotor corresponds to one set of slots of said plurality of slots in said stator and forms a magnetic pole, an effective magnetic pole opening angle, opening to said set of slots and having a vertex on the rotor axis, for the magnetic pole for said one set of slots falls in an angular range effective for reducing harmonic of the specific order in superimposition on a magnetic flux waveform passing through one of said plurality of teeth portions.

A second aspect of the present invention provides the electric rotating machine which, in addition to the specified matters according to the above-mentioned first aspect, is that when a magnetic flux barrier is formed along an outer edge side of the one set of permanent magnets for restricting sneak flux, said magnetic pole involves an outer edge portion of the flux barrier.

A third aspect of the present invention provides the electric rotating machine which, in addition to the specified matters according to the above-mentioned first or second aspect, is that said one magnetic pole in said rotor is formed by embedding said one set of permanent magnets so that permanent magnets of a pair are located in a “V” shape configuration opening towards the peripheral surface of said rotor, slots of said one set are six in number, and said one magnetic pole is arranged so that said effective magnetic pole opening angle θ falls in the angular range 144°≦θ (in electric degrees)≦154.3°.

Thus, according to the above-mentioned first aspect of the present invention, an electric rotating machine is enabled to locate and embed a set of permanent magnets in a rotor that face teeth portions of a stator so that an effective magnetic pole opening angle for the magnetic pole is effective for reducing harmonic of the specific order in superimposition on a magnetic flux waveform. This enables the machine to reduce torque ripple, (i.e., the difference between maximum and minimum torque during one revolution) during revolution of the rotor, realizing high quality operation with less oscillation and noise, and at the same time, high efficiency operation with little losses.

According to the second aspect of the present invention as mentioned above, the electric rotating machine is enabled to place permanent magnets as embedded in the rotor and derive the effective magnetic pole opening angle by involving (or considering) a flux barrier formed along an outer edge side of the permanent magnet in a magnetic pole. This enables realization of effective reduction in torque ripple and also high quality operation with less oscillation, noise and little losses because the effective magnetic pole opening angle for the magnetic pole is derived with high accuracy.

According to the third aspect of the present invention as mentioned above, when permanent magnets of a pair are located in a “V” shape configuration and one magnetic pole corresponds to a set of six slots, the effective magnetic pole opening angle θ (in electric degrees) takes the most suitable electric degrees falling in a range including and between 144° and 154.3°. This enables the electric rotating machine to realize reduction in torque ripple and high quality operation with less oscillation, noise and little losses.

### BRIEF DESCRIPTION OF THE DRAWINGS

FIG. 1 is a plan view showing one implementation of an electric rotating machine according to the present invention, showing the outline of its overall structure.

FIG. 2 is a fragmentary plan view showing an effective magnetic pole opening angle for a magnetic pole in the machine.

FIG. 3 is a plan view showing magnetic flux flow pattern produced by a stator of the machine when a rotor of the machine has no magnetic poles.

FIG. 4 is a graphical representation of an approximate waveform of the magnetic flux (the fundamental).

FIG. 5 is a schematic diagram showing the relationship among the approximate waveform of the magnetic flux, the effective magnetic pole opening angle and a magnet opening angle.

FIGS. 6A and 6B are schematic diagrams illustrating an oscillation or vibration mode generated in the stator.

FIGS. 7A and 7B are schematic diagrams illustrating another oscillation or vibration mode in the stator different from the vibration mode of FIGS. 6A and 6B.

### DESCRIPTION OF IMPLEMENTATION

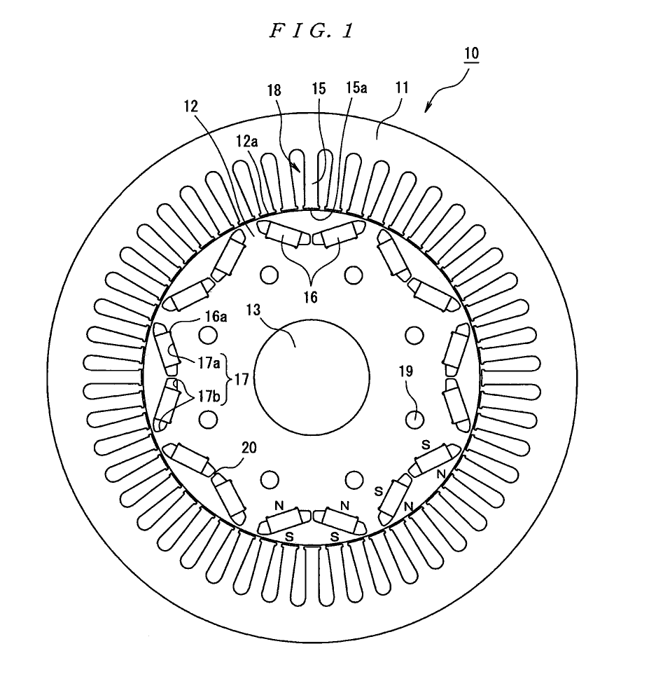

Referring to the accompanying drawings, implementations of the present invention are specifically explained below. FIGS. 1 through 7B show one implementation of an electric rotating machine according to the present invention.

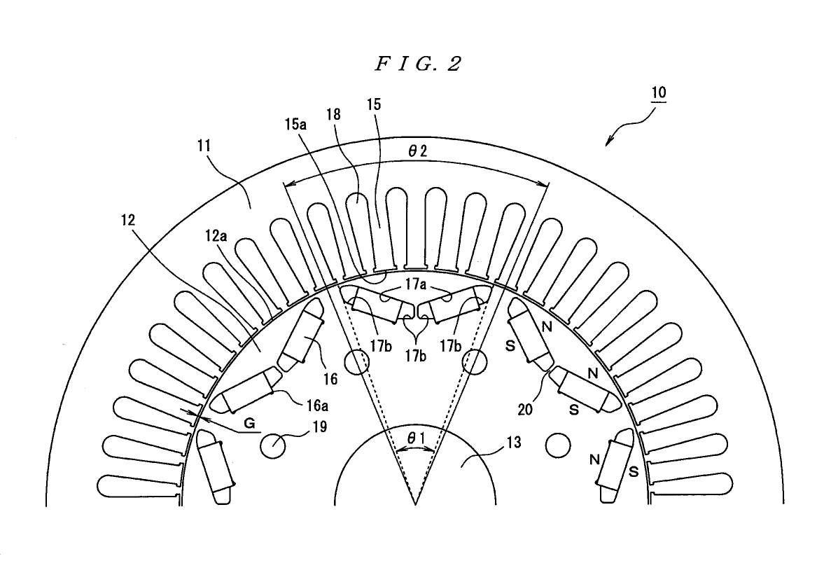

Referring to FIGS. 1 and 2, an electric rotating machine (motor) 10 has a good performance for use in, for example, a hybrid electric car or electric car as a driving source in a manner similar to an internal combustion engine or as an in-wheel drive unit, and it includes a stator 11 formed in a cylindrical configuration and a rotor 12 rotatably received in the stator 11 with a rotor shaft 13 in a way that the rotor 12 is located on a rotor axis that is common to an axis for the stator 11.

With an air gap G between the stator 11 and the rotor 12, the stator 11 includes slots 18 extending toward the rotor axis throughout an inner circular margin, and a plurality of stator teeth 15 defined by the slots 18. The stator teeth 15 extend in radial directions toward the rotor axis with their ends facing an outer circular periphery surface 12a of the rotor 12 with the air gap G between them. The stator teeth 15 are wound to provide a three-phase distributed winding (not shown) to form coil windings configured to induce flux patterns for creation of rotor torque imparted to the rotor 12.

The rotor 12 is an interior permanent magnet (IPM) rotor which has embedded therein a plurality of sets (pairs in this example) of permanent magnets 16 in a way that magnets of each set include a pair of permanent magnets 16 located in a “V” shape configuration opening toward its outer circular periphery surface 12a. The rotor 12 is formed with a plurality of pairs of bores 17 which are located in a “V” shape configuration opening toward the outer circular periphery surface 12a and extend axially through the rotor 12. The bores 17 of each pair include a pair of bore sections 17a in which the permanent magnets 16 of each pair, which are tabular magnets, are accommodated and kept immobile with their corner portions 16a each inserted into and held in a face-to-face relationship to the adjacent two angled inner walls defining the corresponding bore section 17a. Each of the bores 17 includes two space sections 17b that are located on the opposite sides of the corresponding tabular magnet 16 and spaced in a width direction of the magnet 16 to function as flux barriers for restricting sneak flux (called hereinafter “flux barriers”). The bores 17 of each pair are provided with a center bridge 20 interconnecting the permanent magnets 16 of the associated pair in order to retain the permanent magnets 16 in appropriate position against the centrifugal force at high speed revolutions of the rotor 12.

In this electric rotating machine 10, the stator teeth 15 are angularly distant to provide spaces, as the slots 18, to accommodate coil windings, so that six stator teeth 15 cooperate with the corresponding one of eight sets of permanent magnets 16, in other words, six (6) slots 18 face one of eight sets of permanent magnets 16. For this reason, the electric rotating machine 10 is configured to act as an 8-pole 48-slot three-phase IPM motor including eight (8) magnetic poles (four pairs of magnetic poles) for eight (8) sets of permanent magnets 16, in which N-poles and S-poles of the permanent magnets 16 of each set are rotated 180 in mechanical degrees with respect to those of the adjacent set, and forty eight (48) slots 18 accommodating coil windings formed by a single phase distributed winding using six (6) slots 18 defining five (5) stator teeth 15. The illustrated labeling N and S are used for the convenience sake in this explanation, but they are not on the surfaces of the components.

This structure causes the electric rotating machine 10 to drive the rotor 12 and the rotor shaft 13 when the coil windings in the slots 18 are excited so that magnetic flux flow patterns pass from the stator teeth 15 into the rotor 12 inwardly from the outer circular periphery surface 12a because rotor torque is created by, in addition to magnet torque derived from attraction and repulsion by interaction of the magnetic flux flow patterns with flux flow patterns for the magnetic poles for the permanent magnets 16 of each set, reluctance torque tending to minimize magnetic flow paths for the magnetic flux flow patterns from the stator 11.

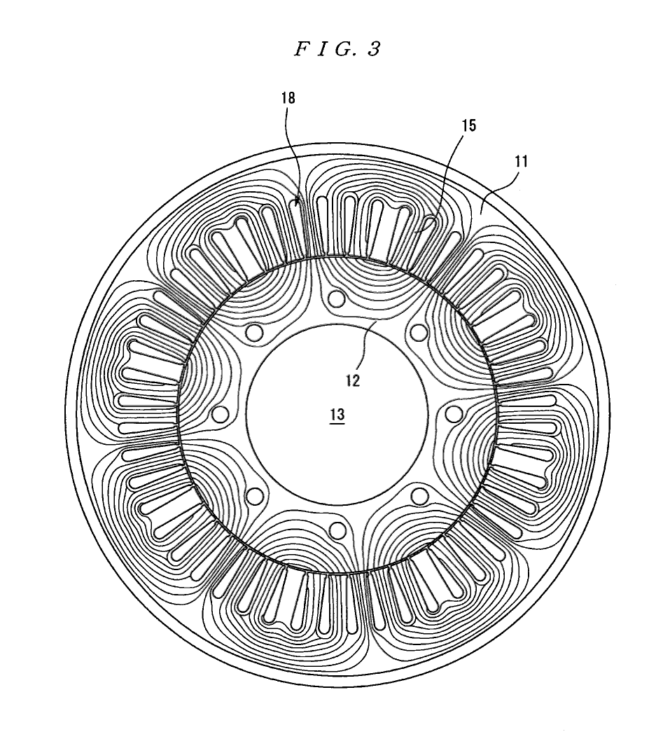

As shown in FIG. 3, the electric rotating machine 10 has the coil windings accommodated in the slots 18 formed by the distributed winding so as to provide a flux flow pattern, which includes distributed magnetic paths, from the stator 11 into the rotor 12 for each of a plurality sets of stator teeth 15 corresponding to one of the magnetic poles for the plurality pairs of permanent magnets 16. The V shape bores 17 of each pair for the permanent magnets 16 extend along the magnetic paths or, in other words, in a manner not to disturb formation of such magnetic paths. It is noted that laminations of magnetic steel such as, silicon steel or the like, are arranged in stacked axial relation to an appropriate thickness for a desired output torque and fastened by fastening screws using tappet holes 19 in a manufacturing process of the stator 11 and the rotor 12.

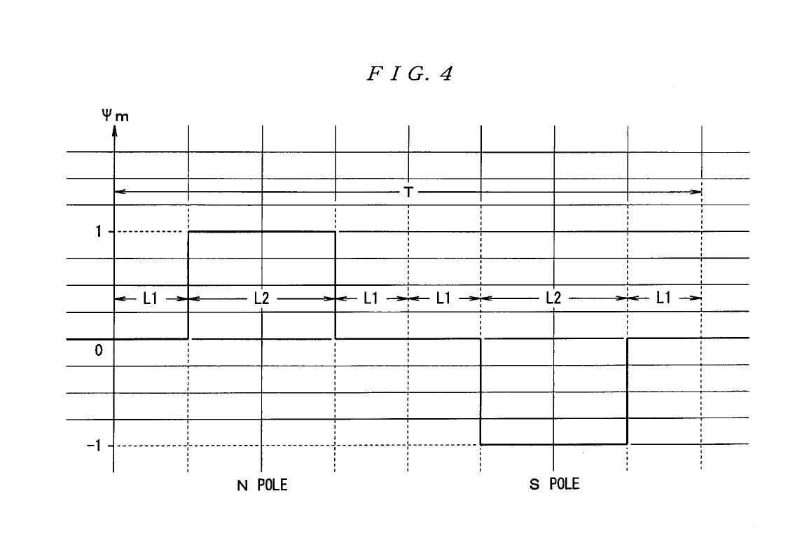

Considering now the electric rotating machine 10 employing the IPM structure in which the permanent magnets 16 are embedded in the rotor 12, the variation of the magnetic flux in one tooth of the stator teeth 15 of the stator 11 may be approximated by a square waveform shown in FIG. 4. Superposition of this fundamental magnetic flux wave and space harmonics of the lower order, the fifth (5^{th}) and the seventh (7^{th}) harmonic, are a factor that affects not only oscillation and noise experienced by the vehicle occupants, but also iron losses and a decrease in machine operating efficiency derived from a loss as thermal energy created by high torque ripple, (i.e., the difference between maximum and minimum torque during one revolution). Suppressing the space harmonics reduces the iron losses to improve machine operating efficiency with respect to input of electrical energy because hysteresis loss is the product of frequency and magnetic flux density and eddy current loss is the product of the square of frequency and magnetic flux density. Turning to FIG. 4 with the vertical axis representing magnetic flux and the horizontal axis representing time, the illustrated square waveform approximates the variation of the magnetic flux in one tooth of the stator teeth 15 over one cycle T (4L1+2L2) in electrical degrees in which no magnetic flux passes through the tooth for a duration L1 and magnetic flux with an amplitude passes forwardly through the tooth for a duration L2 of the first half of the cycle T and reversely through the tooth for the duration L2 of the second half of the cycle T.

Electromagnetic noise from the motor (electric rotating machine) is generated by oscillation of the stator caused by electromagnetic force acting on the stator. As the electromagnetic force acting on the stator, there exist radial electromagnetic force derived from magnetic coupling between the rotor and the stator and angular electromagnetic force derived from torque. Considering radial electromagnetic force acting on each of the stator teeth 15 with a linear magnetic circuit approximating the motor, the radial electromagnetic force fr and magnetic energy W can be expressed in the following formulae (1) and (2) as

$$\begin{matrix}W = \frac{1}{2} {φ}^{2} {R}_{g} = \frac{1}{2} {( B \cdot S )}^{2} \cdot \frac{x}{μ S} = \frac{1}{2 μ} {B}^{2} \cdot x \cdot S & ( 1 ) \\ fr = \frac{\partial W}{\partial x} = \frac{1}{2 μ} {B}^{2} S \frac{\partial }{\partial x} ( x ) = \frac{1}{2 μ} {B}^{2} S & ( 2 )\end{matrix}$$

where φ is the magnetic flux, W is the magnetic energy, fr is the radial electromagnetic force, Rg is the reluctance, B is the magnetic flux density, S is an area through which the magnetic flux passes, x is the air gap (C) length, and ε is the permeability in magnetic path.

Taking space harmonics into account, the flux density B can be expressed as shown in the following formula (3), so it follows that the superposition of the fundamental and the space harmonics is a factor that increases the radial electromagnetic force fr because the radial electromagnetic force fr includes the square of the flux density B. Diligent examination and study by the inventor has proven that reducing the space harmonics lowers torque ripple, resulting in realization of not only a reduction in motor electromagnetic noise, but also an improved machine operating efficiency.

$$B = {\sum }_{t = 1}^{t} Bt sin t ( θ + δ t ) \qquad ( 3 )$$

Inventor's diligent examination and study have proven also that torque ripple in an IPM three-phase motor results from the 6f^{th} (where f=1, 2, 3, . . . : the natural number) harmonic components at θ in electrical degrees, which result from combining, with respect to one phase for one magnetic pole, space harmonics with time harmonics contained in the input phase current supply.

More precisely, three-phase output P(t) and torque τ(t) can be given by the expressions in the following formulae (4) and (5).

P(t)=Eᵤ(t)Iᵤ(t)+Eᵥ(t)Iᵥ(t)+E_{w}(t)I_{w}(t)=ωₘ·τ(t) (4)

τ(t)=[Eᵤ(t)Iᵤ(t)+Eᵥ(t)Iᵥ(t)+E_{w}(t)I_{w}(t)]/ωₘ (5)

where ωₘ is the angular velocity; Eᵤ(t), Eᵥ(t) and E_{w}(t) are the U phase, V phase and W phase induced voltages, respectively; and Iᵤ(t), Iᵥ(t) and I_{w}(t) are the U phase, V phase and W phase currents, respectively.

Three phase torque is the sum of the U phase, V phase and W phase torques. Assuming that m is the order of harmonic component in the current and n is the order of harmonic component in the voltage, the U phase induced voltage Eᵤ(t) can be written as in the following formula (6) and the U phase current Iᵤ(t) can be written as in the following formula (7), and the U phase torque τᵤ(t) can be given by the expression shown in the following formula (8)

$$\begin{matrix} {E}_{u} ( t ) = {\sum }_{n = 1}^{n} {E}_{n} sin n \cdot ( θ + {α}_{n} ) & ( 6 ) \\ {I}_{u} ( t ) = {\sum }_{m = 1}^{m} {I}_{m} sin m \cdot ( θ + {β}_{m} ) & ( 7 ) \\ {τ}_{u} ( t ) = \frac{1}{{ω}_{m}} [ {\sum }_{n = 1}^{n} {\sum }_{m = 1}^{m} {E}_{m} {I}_{m} \{ - \frac{1}{2} \begin{matrix}( cos ( ( n + m ) θ + n {α}_{n} + m {β}_{m} )\end{matrix} - cos ( ( n - m ) θ + {α}_{n} - m {β}_{m} ) \} ] & ( 8 )\end{matrix}$$

It is well known that phase voltage E(t) and phase current I(t) are symmetrical waves, so n and m are odd numbers only. It is further known that the V phase induced voltage Eᵥ(t) and current Iᵥ(t) for the V phase torque and the W phase induced voltage E_{w}(t) and current I_{w}(t) for the W phase torque are +2π/3 radians and −2π/3 radians shifted from the U phase induced voltage Eᵤ(t) and current Iᵤ(t) for the U phase torque, respectively. It is seen that, in the expression of the three-phase torque, terms with coefficient 6 only remain and all of the other terms are cancelled each other. It follows that the three-phase torque τ(t) can be written as in the following formula (9).

$$τ ( t ) = \frac{1}{{ω}_{m}} [ {\sum }_{n = 1}^{n} {\sum }_{m = 1}^{m} {E}_{m} {I}_{m} \{ - \frac{1}{2} \{ 3 cos ( 6 f θ + s ) - 3 cos ( 6 f θ + t ) \} \} ] \qquad ( 9 )$$

where 6f=n±m (f is the natural number), s=nαₙ+mβₘ, t=nαₙ−mβ.

It has become clear from the above formula that when the order n of space harmonics contained in the flux (induced voltage) and the order m of time harmonics contained in the phase supply current are combined to give the number 6f, torque ripples of the 6f^{th} order are generated in the three-phase AC motor because, as an induced voltage is known as the time derivative of a magnetic flux, the harmonics contained in the induction voltage for each phase are of the same order as the harmonics contained in one phase one magnetic pole flux of the same phase.

Now, torque ripples are generated in the three-phase motor upon superposition of the fundamental and space harmonics of the order n=5, 7, 11, 13 in sine-approximation method with, for example, only time harmonic of the order m=1 contained in phase current because torque ripples are generated when the order m of space harmonic in magnetic flux waveform of one phase for one magnetic pole and the order n of time harmonic in phase current of the same phase are combined to meet the condition that n±m=6f (f is the natural number).

For a three-phase IMP motor like the electric rotating machine 10 having six (6) slots 18 per each magnetic pole and twelve (12) slots 18 correspond to each pair of magnetic poles, reluctance becomes high in some of all of the slots 18 at circumferentially spaced twelve (12) positions during one cycle in electrical degrees, causing superposition of the fundamental flux waveform and the eleventh (11^{th}) and thirteenth (13^{th}) space harmonics (n=11, 13). Torque ripple components resulted by these eleventh (11^{th}) and thirteenth (13^{th}) space harmonics (n=11, 13), so-called “slot harmonics”, may be easily reduced by rotating the permanent magnets 16 with respect to the rotor axis by a skew angle that is determined depending on an axial position of the magnets 16.

However, it is difficult to reduce torque ripple components resulted by the fifth (5^{th}) and seventh (7^{th}) space harmonics (n=5, 7), i.e., harmonics of 6^{th} order because 6f=6, because, as shown in FIG. 4, the flux waveform derived from flux linkage of magnetic field at one of the stator teeth 15 approximates square waveform and thus makes it easy for the 5^{th} and 7^{th} harmonics to superimpose the fundamental flux waveform.

Fourier transform equation f(t) when the flux waveform in one of the stator teeth 15 for the three-phase IPM structure is approximated to a square waveform can be given by the expression in the following formula (10), and the flux waveform F(t) shown in FIG. 4 can given by the expression in the following formula (11). This flux waveform F(t) can be written as the following formula (12), an approximation formula including space harmonics not higher than the 7^{th} harmonic, which in turn can be transformed to the following formula (13) by the arrangement of the terms given after expansion using the sum to product formulae in trigonometry. This formula (13) makes it clear that satisfying the following condition 1 or 2 is needed for reduction of the 5^{th} or 7^{th} harmonic.

cos 5ω·L1=0 Condition 1:

cos 7ω·L1=0 Condition 2:

$$\begin{matrix} f ( t ) = \frac{4}{π} {\sum }_{k = 1}^{∞} \frac{sin \{ ( 2 k - 1 ) ω t \}}{2 k - 1} & ( 10 ) \\ \begin{matrix} F ( t ) = \frac{1}{2} [ f ( t - α ) + f ( t + α ) ] \\ = \frac{1}{2} [ \begin{matrix}\frac{4}{π} {\sum }_{k = 1}^{∞} \frac{sin \{ ( 2 k - 1 ) ω ( t - α ) \}}{2 k - 1} + \\ \frac{4}{π} {\sum }_{k = 1}^{∞} \frac{sin \{ ( 2 k - 1 ) ω ( t + α ) \}}{2 k - 1}\end{matrix} ]\end{matrix} & ( 11 ) \\ F ( t ) = \frac{1}{2} [ \frac{4}{π} \{ sin ω ( t - α ) + \frac{1}{3} sin 3 ω ( t - α ) + \frac{1}{5} sin 5 ω ( t - α ) + \frac{1}{7} sin 7 ω ( t - α ) \} + \frac{4}{π} \{ sin ω ( t + α ) + \frac{1}{3} sin 3 ω ( t + α ) + \frac{1}{5} sin 5 ω ( t + α ) + \frac{1}{7} sin 7 ω ( t + α ) \} ] & ( 12 ) \\ F ( t ) = \frac{4}{π} [ sin ω t \cdot cos ωα + \frac{1}{3} sin 3 ω t \cdot cos ωα + \frac{1}{5} sin 5 ω t \cdot cos 5 ωα + \frac{1}{7} sin 7 ω t \cdot cos 7 ωα ] & ( 13 )\end{matrix}$$

Referring to the flux waveform shown in FIG. 4, its behavior can be expressed as the following formula (14). Substituting this formula into the relationship (i.e., 5ω·L1=±π/2) derived from the condition 1 gives the expression in the following formula (15), called “condition 1 as modified”. Rewriting this expression using the fact that L1, L2>0 can give the expression in the following condition 1A. It is noted that the condition 1A provides reduction of torque ripple by lowering the 5^{th} space harmonic to zero when it is satisfied.

Angular frequency (angular velocity) ω=2π/T=2π/(4L1+2L2) (14)

Condition 1 as modified: 5ω·L1=5·2πL1/(4L1+2L2)=±π/2

Condition 1A: L1=L2/8 (15)

Similarly, condition 2 as modified can be written as the following formula (16). Rewriting this expression using the fact that L1, L2>0 can give the expression in the following condition 2A. It is noted that the condition 2A provides reduction of torque ripple by lowering the 7^{th} space harmonic to zero when it is satisfied.

Condition 2 as modified: 7ω·L1=7·2πL1/(4L1+2L2)=±π/2

Condition 2A: L1=L2/12 (16)

For the 8-pole 48-slot electric rotating machine 10, the periphery speed V of the rotor 12 is expressed, using the following relationship that holds in the machine 10, in the following formula (17) which is rewritten as the following formula (18), where r is the radius of the rotor 12.

45 in mechanical degrees=T/2 cycle in electric degrees

$$\begin{matrix}\begin{matrix}V ( m \text{/} sec ) = 2 π r \cdot ( 45 ° / 360 ° ) / ( T / 2 ) \\ = 2 π r \cdot ( 45 ° / 360 ° ) / \{ ( 4 L 1 + 2 L 2 ) / 2 \} \\ = r ( m ) \cdot ω ( rad \text{/} sec )\end{matrix} & ( 17 ) \\ 2 L 1 + L 2 = π / 4 ω & ( 18 )\end{matrix}$$

Substituting the condition 1A and the condition 2A in the above-mentioned formula (18) gives the following conditions.

The 5^{th} space harmonic=0→(L2,L1)=(π/5ω,π/40ω)

The 7^{th} space harmonic=0→(L2,L1)=(3π/14ω,π/56ω)

This increases tendency to reduce the 5^{th} and 7^{th} space harmonics in the electric rotating machine 10 to restrain torque ripple from increasing by providing a layout that satisfies the following chained notation of inequalities (19)

π/5ω≦L2≦3π/14ω(sec) (19)

Here, the term L2 in the chained notation of inequalities (19) represents that area on the side of the rotor 12 facing the stator teeth 15 which provides a magnetic path for the magnetic flux having the flux waveform shown in FIG. 4, and thus it may be interpreted as an arc in the air gap G interconnecting those two lines diverging from the rotor axis (the vertex) and passing through the flux barriers 17b of both sides of a given pair of permanent magnets 16 which form a divergence angle θ1, called “the effective magnetic pole opening angle θ1”.

Referring to the flux waveform shown in FIG. 4, the effective magnetic pole opening angle θ1 can be written as θ1=ωL2 because the relationship that θ=ωt holds, so the chained notation of inequities (19) can be written as various expressions as follows. In the case of the configuration of the 8-pole 48-slot electric rotating machine 10 (the configuration in which six (6) slots correspond to or face eight (8) magnetic poles one after another), for example, one cycle of the rotor 12 over 360 in mechanical degrees corresponds to four cycles in electric degrees because each of four pairs of eight (8) magnetic poles experiences one cycle. The various expressions are:
π/5 (rad)≦θ1 (in mechanical degrees)≦3π/14 (rad), and
36 (deg rees)≦θ1 (in mechanical degrees)≦270/7 (deg rees).
   Since θ1 (in mechanical degrees)=(8 poles/2 poles)·θ1 (in electric degrees),
144 (degrees)≦θ1 (in electric degrees)≦154.3 (degrees).

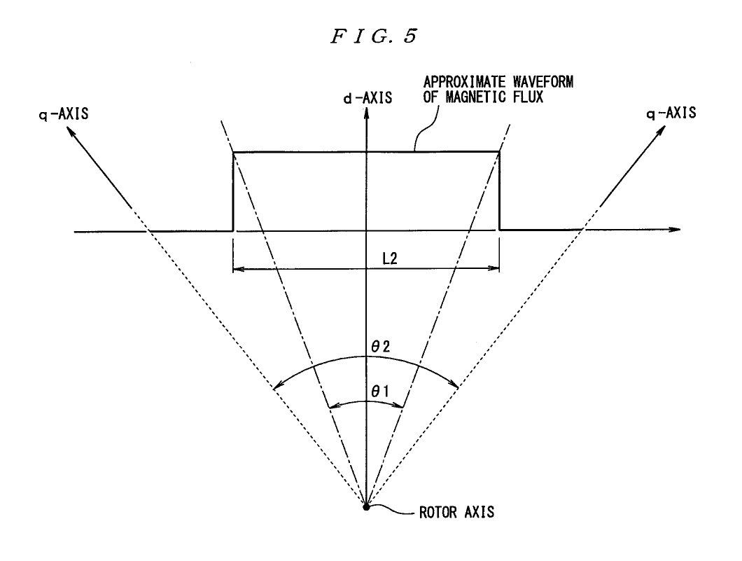

As shown in FIG. 5, this leads to layout, per one magnet pole in the electric rotating machine 10, of the permanent magnets 16 with their flux barriers 17b at one and the opposite edges within an area bounded by those two lines diverging from the rotor axis (the vertex) which form the effective magnetic pole opening angle θ1, which falls in a range expressed as follows:
36°≦θ1 (in mechanical degrees)≦38.6° or
144°≦θ1 (in electric degrees)≦154.3°.

In the IPM structure in which the permanent magnets 16 of each pair, embedded in the rotor 12, are located in a “V” shape configuration, a d-axis represents a direction of magnetic flux generated by magnetic poles, that is, a center axis between each pair of permanent magnets 16 located in “V” shape, while a g-axis represents an axis that is at an angle of 90 in electric degrees from the d-axis electrically and magnetically and acts as a center axis between the permanent magnets 16 of the adjacent magnetic poles. In this situation, the effective magnetic pole opening angle θ1 per magnetic pole in the rotor 12 corresponds to the duration L2 that the magnetic flux passing through the stator teeth 15 continues as readily seen from the waveform approximating the magnetic flux waveform shown in FIG. 4. As shown in FIG. 5, the magnetic flux waveform has its duration L2 located at the midpoint between the q-axes of each pair forming an angle θ2 so that the d-axis passes through the midpoint of the duration L2. The illustrated angle θ2 of FIG. 2 is an angle formed by the q-axes of each pair and 45° in mechanical degrees, and an angle in electric degrees corresponding to half the cycle in the magnetic flux waveform.

Accordingly, with the effective magnetic pole opening angle θ1 that covers not only the permanent magnets 16 of each pair but also their flux barriers 17b in the rotor 12, falling in the range {144°≦θ1 (in electric degree)≦154.3°} which is effective for torque ripple reduction by suppressing the 5^{th} and 7^{th} space harmonics, n=5, 7, in the phase voltage, each of which cooperates with the time harmonic in the phase current of the order m=1 to satisfy the specific order of the 6f^{th} (n=5, 7), the electric rotating machine 10 is enabled to drive its rotor shaft 13 with the high quality rotation of reduced torque ripple, oscillation and noise. Besides, it is enabled to drive the rotor shaft 13 with the high efficient rotation of reduced losses because the reduced torque ripple reduces oscillation to suppress not only heat loss, but also hysteresis and iron loss.

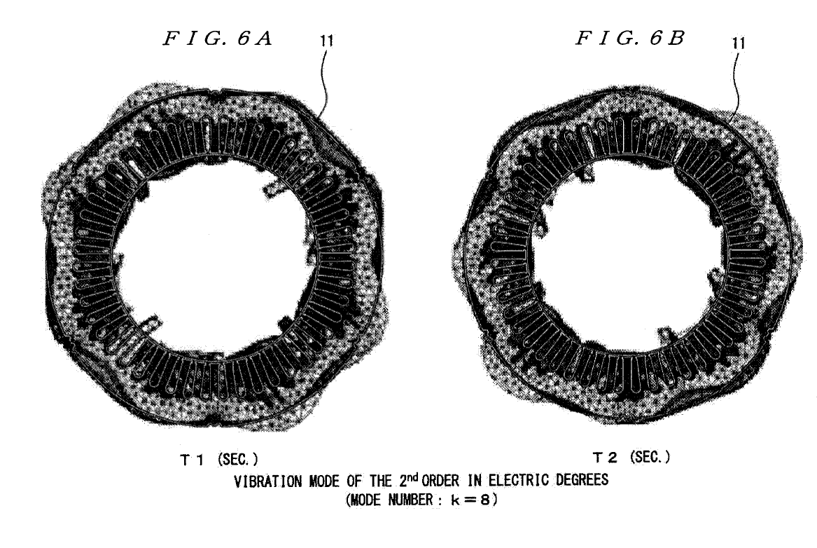

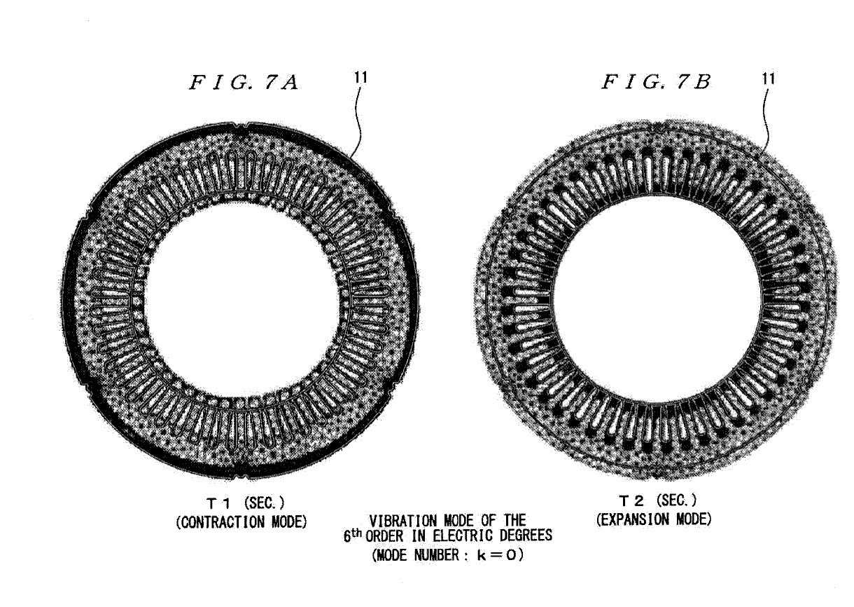

For investigating a three phase IPM motor which the electric rotating machine 10 adopts as its fundamental structure, vibration analysis of the stator 11 (stator iron core) has been made. This analysis has clarified that the vibration mode shape of a revolving octagon (mode number k=8) is generated by the 2^{nd}, 4^{th}, 8^{th}, 10^{th} orders of the radial electromagnetic force fr, see formula (2), which are generated due to the superposition of the fundamental wave (t=1), 3^{rd} space component (t=3), 5^{th} space component (t=5) as expressed in the before-mentioned formula (3), and the vibration mode shape of a perfect circle having cyclic expansion and contraction (mode number k=0) is generated by the 6^{th}, 12^{th}, orders of the radial electromagnetic force fr. For example, in the vibration mode generated by the 2^{nd} harmonic (or the 2^{nd} order of the radial electromagnetic force fr) shown at two different timings T1 and T2 in FIG. 6A and FIG. 6B, the octagon that is transformed by the vibration of stator 11 revolves, and in the oscillation mode generated by 6^{th} harmonic (or the 6^{th} order of the radial electromagnetic force fr) shown at two different states of timings T1 and T2 in FIG. 7A and FIG. 7B, the stator 11 cyclically expands and contracts. Furthermore, in the vibration mode generated by the 10^{th} order of the radial electromagnetic force fr, not illustrated, the vibration mode shape of an oval is combined with the vibration mode shape of an octagon (mode number k=8).

In the electric rotating machine 10 in the form of an 8-pole 48-slot motor, the magnetic flux density is distributed so that eight (8) magnetic fluxes are positioned one after another in angular direction with respect to one revolution through 360 in mechanical degrees and the eight (8) radial electromagnetic forces fr are positioned one after another in angular direction, so that the eight angularly positioned radial electromagnetic forces fr induce the vibration mode with its mode number k=8. Furthermore, in the vibration mode generated by the 6^{th}, 12^{th} order radial electromotive force fr, the stator 11 is vibrated by an electromagnetic force composite vector that is the sum of an electromagnetic force vector due to torque ripple and an electromagnetic force radial vector due to the magnetic coupling with the stator 11. Thus, during the vibration mode k=0, in which expansion and contraction alternately occur, generated by the 6f^{th} order accompanied by torque ripple, that is, the 6^{th}, 12^{th} orders in this example, the circumferential air of the stator 11 propagates the vibration caused by the expansion and contraction, causing an increase in the degree of motor electromagnetic noise of the electric rotating machine 10 as compared to the other orders. For the other orders excluding the above-mentioned 6f^{th} order, no torque ripple occurs and no vibration and noise that may create a problem occur.

As a result of this, it is made clear that, in the electric rotating machine 10, suppressing the harmonics of 6^{th} order (m=1, n=5, 7) in the magnetic flux waveform, which is considered to create a problem, provides a reduction in torque ripple and judder, suppressing not only abnormal vibration in its installed state in a car, called “judder”, but also electromagnetic noise. Those harmonics of the orders combined to make the 6f^{th} which generate the vibration mode k=0, for example, the 12^{th} harmonic, may be reduced by, for example, giving a skew angle upon embedding the permanent magnets 16.

From the preceding description, it is made clear that the present embodiment has accomplished high quality rotation of reduced oscillation and noise and also high efficient rotation of reduced losses with the effective magnetic pole opening angle θ1 that covers not only the permanent magnets 16 of each set or pair, in this example, but also their flux barriers 17b in the rotor 12 facing the stator teeth 15 of the stator 11, falling in the range {144°≦θ1 (in electric degree)≦154.3°} considered effective for suppressing the space harmonics responsible for torque ripple, each of which has the order, upon combined with the order of the fundamental time harmonic, makes the specific order of the 6^{th}.

During the description of the present embodiment, an electric rotating machine 10 in the form of an 8-pole 48-slot motor is taken as an example, but it not limited to this structure. The present invention may find its application in motors including six (6) slots to each magnetic pole, such as, a 6-pole 36-slot, 4-pole 24-slot, 10-pole 60-slot motor, by employing only θ1 in electric degrees in the range of the effective magnetic pole opening angle θ1.

It is not intended to limit the scope of the present invention to the embodiment illustrated and described. It should be appreciated that all of variants accomplishing equivalent effect(s) which are aimed at by the present invention exist within the scope of the present invention. It should be understood that various changes can be made in the function and arrangement of elements without departing from the scope of the present invention as set forth in the appended claims and the legal equivalents thereof.

### INDUSTRIAL APPLICABILITY

It should be appreciated that, although one embodiment of the present invention has been described, it is just an example and not intended to limit the scope of the present invention. It should also be appreciated that a vast number of variants exist without departing from the spirit of the present invention.

### EXPLANATION OF NOTATIONS

10 electric rotating machine
11 stator
12 rotor
13 rotor shaft
15 stator teeth
16 permanent magnet
16a corner portion
17 bores which are located in a “V” shape
17b flux barrier
18 slot
20 center bridge
θ1 effective magnetic pole opening angle

1. An electric rotating machine comprising a rotor with a rotor shaft located on a rotor axis and a stator rotatably receiving the rotor,
wherein said stator includes a plurality of teeth portions, which extend towards a peripheral surface of said rotor and terminate at inner peripheral surfaces facing the peripheral surface of said rotor, and a plurality of slots, each between the adjacent two of the teeth portions, providing spaces for winding coils around said teeth portions for input of driving electric power,
wherein said rotor has a plurality of permanent magnets embedded therein so as to let magnetic force act on that surface portions of the teeth which are opposed to the permanent magnets,
wherein said rotor within said stator is driven to revolve by reluctance torque derived from magnetic flux passing through said teeth portions, rear surface side of the teeth portions and said rotor when current passes through said coils and magnet torque in the form of attraction and repulsion derived from interference with said permanent magnets,
wherein said permanent magnets are located in a way that when a set of permanent magnets of said plurality of permanent magnets in said rotor corresponds to one set of slots of said plurality of slots in said stator and forms a magnetic pole, an effective magnetic pole opening angle, opening to said set of slots and having a vertex on the rotor axis, for the magnetic pole for said one set of slots falls in an angular range effective for reducing harmonic of the specific order in superimposition on a magnetic flux waveform passing through one of said plurality of teeth portions.

2. The electric rotating machine according to claim 1, wherein when a magnetic flux barrier is formed along an outer edge side of the one set of permanent magnets for restricting sneak flux, said magnetic pole involves an outer edge portion of the flux barrier.

3. The electric rotating machine according to claim 1, wherein said one magnetic pole in said rotor is formed by embedding said one set of permanent magnets so that permanent magnets of a pair are located in a “V” shape configuration opening towards the peripheral surface of said rotor, slots of said one set are six in number, and said one magnetic pole is arranged so that said effective magnetic pole opening angle θ falls in the angular range 144°≦θ (in electric degrees)≦154.3°.
